(19) United States
(12) Patent Application Publication
(10) Pub. No.: US 2026/0126021 A1
(43) Pub. Date: May 7, 2026

(54) FILTER MEDIUM AND METHOD OF PRODUCTION THEREOF

(71) Applicant: Neenah Gessner GmbH, Bruckmühl (DE)

(72) Inventors: Peter KOPPI, St. Margarethen (AT); Fabian NUTZ, Holzkirchen (DE); Wolfgang ZUPANC, Klagenfurt (AT); Birgit RENZ, Marbach (DE)

(21) Appl. No.: 19/118,227

(22) PCT Filed: Oct. 5, 2023
(86) PCT No.: PCT/EP2023/077648

§ 371 Date: Apr. 3, 2025

(30) Foreign Application Priority Data
Oct. 6, 2022 (DE) 20 2022 105 638.2

(51) Int. Cl. F02M 25/022; B01D 39/16

(52) U.S. Cl. CPC F02M 25/0224; B01D 39/1623; B01D 2239/0233; B01D 2239/0258; B01D 2239/0442; B01D 2239/0622; B01D 2239/0627; B01D 2239/065; B01D 2239/0677; B01D 2239/1216; B01D 2239/1233; B01D 2239/1258; B01D 2239/1291

(57) ABSTRACT

The present invention relates to a filter medium comprising an antimicrobial compound, a method for producing the filter medium, the filter element, a filter system as well as the use of the filter medium for the filtration of water in the combustion chamber of an internal combustion engine.

### CROSS-REFERENCE TO RELATED APPLICATIONS

This application is a national stage application, filed under 35 U.S.C. § 371, of International Patent Application No. PCT/EP2023/077648 filed on Oct. 5, 2023, which claims priority to German Patent Application No. 202022105638.2, filed Oct. 6, 2022, the entire disclosure of which are incorporated herein by reference for all purposes.

### TECHNICAL FIELD OF THE INVENTION

The present invention relates to a filter medium comprising an antimicrobial compound, a method for producing the filter medium, the filter element, a filter system as well as the use of the filter medium for the filtration of water in the combustion chamber of an internal combustion engine.

### PRIOR ART

In the development of new engine generations, an increasing focus is currently being placed on the reduction of the emission of polluting exhaust gases such as nitrogen oxides (NOx). One possible technical solution for reducing NOx in the exhaust gas is the injection of water into the gas/air mixture in the combustion chamber of the engine. The injection of water into the combustion chamber leads indeed to a reduction of the exhaust gas temperatures as well as to a reduction of premature ignition. However, the use of water also shows some problems related to the presence of impurities in water. Said impurities can cause damages to the components located in the cylinder and, in addition, can favour the growth of microbial species such as bacteria, algae, fungi or other microorganisms.

In patent application DE 10 2017 006 462 A1 (DE '462 in the following) it has been proposed a filter medium comprising a grid as a supporting layer and a meltblown layer as a filtration layer, wherein both the grid and the meltblown layers are impregnated or coated with an antibacterial material. However, this medium shows some disadvantages. First, the presence of the grid leads to increased costs of the medium. Further, the meltblown layer is required to have a high weight and thickness and this not only results in higher costs but also in a reduced number of pleats in the filter. As it is known, the number of pleats have an effect on the filtration surface, which in turn influences the service life, the dust holding capacity and the differential pressure.

Accordingly, there remains a need for a filter medium showing excellent performance in terms of efficiency, dust holding capacity, strength, service life and antimicrobial activity that can be used for the filtration of the water to be injected in the combustion chamber. Further, there remains a need for a filter medium for the filtration of water in the combustion chamber of an internal combustion engine which is cheaper than the filter medium available to date.

### DESCRIPTION OF THE INVENTION

It is an object of the present invention to provide a filter medium showing excellent performances in terms of efficiency, dust holding capacity, strength, differential pressure and service life as well as antimicrobial activity. It is a further object of the present invention to provide a filter medium for the filtration of water in the combustion chamber of an internal combustion engine, which is cheaper than the filter medium available to date.

The filter medium of the present invention is particularly suitable for the filtration of water in the combustion chamber of an internal combustion engine.

The filter medium according to the present invention comprises:
i) a first meltblown layer, and
ii) a second spunbond layer,
   wherein at least one of the first and second layers comprises at least an antimicrobial compound.

The first meltblown layer can be produced according to known manufacturing methods. Suitable polymers to be used for the first meltblown layer are for example polyolefin (such as polypropylene), polyester (such as polyethylene terephthalate and polybutylene terephthalate) and polyamide. Preferably, the meltblown layer comprises polybutylene terephthalate (PBT). Additives such as crystallization promoters and dyes can also be mixed into the polymers.

The average fiber diameter of the first meltblown layer is 0.5-10 μm, preferably 0.5-5 μm and even more preferably 0.5-2 μm. Particularly preferable are fibers having an average fiber diameter of 0.8-1.4 μm.

The first meltblown layer has a basis weight of 30-95 g/m2, preferably 40-90 g/m2 and even more preferably 45-80 g/m2.

The thickness of the first meltblown layer is 0.05-0.80 mm, preferably 0.1-0.6 mm and even more preferably 0.2-0.5 mm (acc. to DIN EN ISO534:2012; 0.1 bar pressure).

Additional meltbown layers can also be present in the filter medium. These may be the same as the first meltblown layer or may have different features in terms of polymer composition, thickness, fiber diameter and basis weight.

The second spunbond layer can be produced according to known manufacturing methods. Suitable polymers are, for example, polyolefin (such as polypropylene), polyester (such as polyethylene terephthalate and polybutylene terephthalate), polyamide or mixture thereof. Preferred polymers are polyester such as polybutylene terephthalate (PBT) and polyethylene terephthalate (PET).

Preferably, the second spunbond layer comprises bicomponent fibers. Example of preferred multicomponent fibers are PET/CoPET bicomponent fibers having core-sheath configuration.

The average fiber diameter of the second spunbond layer is 5-40 μm, preferably 10-30 μm and even more preferably 15-20 μm.

The second spunbond layer has a basis weight of 40-130 g/m2, preferably 50-110 g/m2 and even more preferably 60-90 g/m2.

The thickness (acc. to DIN EN ISO534:2012; 0.1 bar pressure) of the second spunbond layer is 0.09-0.70 mm, preferably 0.10-0.50 mm and even more preferably 0.18-0.40 mm.

A third spunbond layer can also be present in the filter medium of the present invention. The type of polymers and the average fiber diameter for the third spunbond layer are as described above for the second spunbond layer.

The basis weight of the third spunbond layer is 5-40 g/m2, preferably 10-30 g/m2 and even more preferably 15-25 g/m2.

The thickness (acc. to DIN EN ISO534:2012; 0.1 bar pressure) of the third spunbond layer can be 0.08-0.40 mm, preferably 0.09-0.30 mm and even more preferably 0.10-0.20 mm.

When the third spunbond layer is present, it will be placed on the side of the meltblown layer opposite to the second spunbond layer. This third spunbond layer will function as protecting layer for the meltblown layer.

When used within a filter element, the filter medium is employed so that the direction of the flow of the fluid to be passed through the filter medium is through the first meltblown layer or the third spunbond layer, if present. The outflow side is the second spunbond layer.

At least one of the layers in the filter medium comprises an antimicrobial compound. An “antimicrobial compound” refers to any compound that prevents the development of microbial species such as bacteria, algae and/or fungi. The at least one antimicrobial compound can be one selected from the group consisting of metals, metal salts of pyrithione, quaternary ammonium salts, polyelectrolytes, polymeric biguanide derivatives or mixture thereof. The metals and the metal of the metal salts of pyrithione is one selected from the group consisting of copper, zinc and silver or mixture thereof. Metals may be employed in the form of nanoparticles, preferably silver nanoparticles. The quaternary ammonium salt is one selected from the group consisting of benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide. The antibacterial compound can also be selected from the group of polymers e.g. polyelectrolytes such as polycations or polyanions, the salts thereof or from the group of polymeric biguanide derivatives such as Poly(hexamethylene biguanide) hydrochloride. Preferably the at least antimicrobial compound comprises a biguanide derivative.

The at least one layer comprising at least one antimicrobial compound can be impregnated or coated with the antimicrobial compound. Alternatively, the at least one antimicrobial compound can be added to the polymeric material before processing into a meltblown layer and/or a spunbond layer.

The antimicrobial compound may be applied using known techniques, such as spraying, dipping, roller application, foam application, or dusting. A saturating size press or other conventional means may be used, such as curtain coaters, metered press coaters, foam bonders, graver rolls, dip and nip, doctorate transfer rolls, rod coaters, and spray coaters. When the antimicrobial compound is applied in liquid form (as it is the case for example by dipping) the components are mixed together in a solvent. Preferred solvents are water, organic solvents or mixture thereof. Among the organic solvents, alcohols can be mentioned such as methanol or ethanol. Preferably the antimicrobial compound is applied by a Foulard dipping technology.

Preferably, the layer comprising the antimicrobial compound is the first meltblown layer. It is further preferred if only the first meltblown layer comprises the at least one antimicrobial compound. In a preferred embodiment the first metblown layer is coated with the at least one antimicrobial compound and more preferably, this coated first meltblown layer is the only layer comprising an antimicrobial compound.

If not only one layer, such as the first meltblown layer, comprises the antimicronial compound, but more then one layer (depending on the type of filter medium, for example two or three layers, such as the second and third spunbond layers) comprises such a compound, the layers may vary in relation with the type of antimicrobial compound used in the layers (i.e. the same antimicrobial compound is used for the layers or different types of antimicrobial compounds are used), as well as with respect to the amount applied, the way the antimicrobial compound is applied (coated, dispersed within the fibers of a layer etc.) etc.

The filter medium according to the present invention shows an initial efficiency of at least 85%, preferably at least 90% and even more preferably at least 95% at 4 μm particles. The initial efficiency of the filter medium was measured according to ISO 19438:2003 (E) by using A3 medium Test Dust (ISO12103-1, PTI Powder Technology Inc.) on a flat sheet of 200 cm2 with 0.71 L min-1 flowrate, BUGL 100.

The filter medium according to the present invention shows a dust holding capacity of at least 1.3 g/200 cm2, preferably at least 1.5 g/200 cm2 and more preferably at least 1.8 g/200 cm2 at a pressure drop of 0.7 bar (measured according to ISO 19438:2003 but on a flat sheet).

The initial efficiency has also been tested on the filter element according to ISO 19438:2003 (E). The initial efficiency level is at least 85% at 4 μm particles, at least 90% at 5 μm particles, at least 99.9% at 10 μm particles and at least 99.95% at 20 μm particles. The same efficiency levels are achieved when testing the filter element according to the ISO 19438:2003 (E) standard but using micro filtered water instead of the test fluid indicated in this standard. The specific dust holding capacity is at least 75 g/m2 at pressure drop of 0.3 bars according ISO 19438:2003 (E).

Preferably, the filter medium has a diameter of “many pores” according to the pore size measurement described below of 5-30 μm, preferably 10-25. More preferably, the diameter (size) of “many pores” is 7-15 μm.

Preferably, the maximum pore size (diameter) is 15 to 40 μm and more preferably 15-30 μm.

It has been surprisingly found that the antimicrobial compound in the filter medium not only exercised an excellent antimicrobial activity but resulted to be very stable over a long period of time so as to be particularly suitable for water filtration in the chamber of a combustion engine.

The antimicrobial activity of the filter medium has been tested according to DIN EN ISO 20743:2013. In order to adapt this standard to the objective of these investigations and deviating from the standard the microorganisms Pseudomonas aeruginosa and Stenotrophomonas maltophilia were used. The filter medium has an antimicrobial activity of at least 2 log, and preferably at least 4 log, within 24 hour of incubation (i.e. LRF >2 and preferably >4), which corresponds to an inactivation largen than 99.99%.

The influence of pH (i.e. pH 5, 7 and 9) and temperature (5, 30, 80° C.) on the release properties of the coating have also been tested. The media resulted to be stable at the different pH and temperatures even after a period of 3 months and no significant release of the coating could be detected. For example, the coating comprising silver ions showed a release of silver ions at temperatures of 5, 30 and 80° C. and pH values of 5, 7 and 9 smaller than 60 μg/l. The release of ammonium ions at temperature of 5 and 30° C. are smaller than 0,643 mg/l. There is no effect of the bacteria of the releasing behavior. The test conditions are described in the corresponding section.

The filter media can be pleated to a filter element with various pleats depending on the size of the filter element.

The amount of the at least one antimicrobial compound in the filter medium typically is 0,0001 wt %-2,0000 wt %, preferably 0.001 wt %-1.8000 wt % and even more preferably 0.01-1.5 wt %, based on the total weight of the filter medium.

The hydrophobicity of the filter medium is 0. Hydrophobic materials are water-repellent. The water remains in the form of a drop on the surface of the material even after a long time. For this measurement the water absorptive capacity of a substrate is determined. The hydrophobicity can be determinate by applying drops of liquid with different surface tensions. A drop of test liquid from a dropper bottle is applied to the material to be tested. After a dwell time of one minute, it is observed which test liquid mixture remains as drops on the material without penetrating. The test liquids are applied in increasing order. The number of the liquid at which a drop remains for one minute without penetrating the material is used as the result of the measurement. In the present case the test liquid was water (i.e. number is 0).

The filter medium can be produced by bonding the spunbond layer with the meltblown layer. Any known method can be used for bonding such as needling, sputtering, thermal processes (i.e. calandering, ultrasonic welding) and chemical processes (i.e. adhesives). Preferably, the meltblown layer and the spunbond layers are connected by means of a point calander.

The present invention also deals with a filter element and a filter system comprising the inventive filter medium. The filter element may comprise a first and a second endplate wherein between the filter medium is arranged. The filter medium can for example be folded in a zig zag manner and be arranged between the end plates. The filter element can be flowed through radially from the outside to the inside or from the inside to the outside. Beside this, the filter element can have at least one no return valve so that already filtered water cannot flow back through the filter element. The present invention also provides a filter system comprising at least one filter element, a filter element housing and a filter housing cap. The filter element is located in the filter element housing. When the filter element is installed correctly in the housing the raw side will be separated from the pure side by the filter element so that the liquid has to be filtered through the filter medium of the filter element.

The inventive filter medium can be used for the filtration of water in the combustion chamber of an internal combustion engine.

Under due consideration of the above, the present invention in particular provides the following preferred embodiments:

I. A filter medium comprising:
i) a first meltblown layer, and
ii) a second spunbond layer,
   wherein at least one of the first and second layers comprises at least an antimicrobial compound.

II. The filter medium according to I, wherein the at least one antimicrobial compound is selected from the group consisting of metals, metal salts of pyrithione, quaternary ammonium salts, polyelectrolytes, polymeric biguanide derivatives or mixture thereof.

III. The filter medium according to any one of I-II, wherein only the meltblown layer comprises the at least one antimicrobial compound.

IV. The filter medium according to any one of I-III, wherein both the first meltblown layer and the second spunbond layer comprise the at least one antimicrobial compound. The antimicrobial compound may be the same or different in the two layers, and in case the same antimicrobial compound is used, the mayers may in this regard differ relating to the amount of animicrobial compound applied, the way the antimicrobial compound is provided in the layer etc.

V. The filter medium according to any one of I-IV further comprising a third spunbond layer.

VI. The filter medium according to any one of I-V, wherein the first meltblown layer, the second spunbond layer and the third spunbond layer comprise the at least one antimicrobial compound. The antimicrobial compound may be the same or different in the three layers, and in case the same antimicrobial compound is used, the mayers may in this regard differ relating to the amount of animicrobial compound applied, the way the antimicrobial compound is provided in the layer etc.

VII. The filter medium according to any one of I-VI, wherein the first meltblown layer, the second spunbond layer and the third spunbond layer are coated with the at least one antimicrobial compound.

VIII. The filter medium according to any one of I-VII, wherein the meltblown layer comprises polyester fibers.

IX. The filter medium according to any one of I-VIII, wherein the at least one antimicrobial compound is selected from the group consisting of quaternary ammonium salts and polymeric biguanide derivatives.

X. The filter medium according to any one of I-IX, wherein the amount of the at least one antimicrobial compound is 0,0001-2,0000 wt % based on the total weight of the filter medium.

XI. The filter medium according to anyone of I-X, wherein the first meltblown layer has a thickness of 0.05-0.8 mm.

XII The filter medium according to anyone of I-XI, wherein the at least one antimicrobial compound is selected from the group consisting of zink-pyrithion, silver nanoparticles, quaternary ammonium salts and Poly(hexamethylene biguanide) hydrochloride.

XIII. The filter medium according to anyone of I-XII, wherein the at least one antimicrobial compound comprises, or consists of quaternary ammonium salts and Poly(hexamethylene biguanide) hydrochloride.

XIV. A filter element comprising the filter medium according to any one of I-XIII.

XV. The filter element according to XIV comprising a first endplate, a second endplate and a filter medium which can be flowed through radially.

XVI The filter element according to XIV or XV comprising at least one valve especially an anti return valve.

XVII. A Filter system comprising a filter element according to XIV-XVI, a filter element housing and a filter housing cap.

XVIII. Use of the filter medium according to any one of I-XIII for the filtration of water in the chamber of a combustion engine.

### Test Method

Pore size: The pore size is measured with reference to DIN ISO 4003:1990. The sample is placed between an air-tight clamp over an orifice equipped with air supply and a connection to a pressure gauge (U-tube with mm indicator). Each sample is tested with the upper side facing upwards. Denatured ethanol (ethanol 100% with 1% MEK (Methyl-Ethyl-Ketone) as denaturant) is poured over the edge of the upper specimen holder (do not spray directly onto the sample/approx. 4 mm depth) to achieve a slight excess of air pressure on the liquid. The air pressure is slowly increased (approx. 5 mm water gauge/sec) until the first air bubble is visible. The necessary air pressure level is to be read from the pressure gauge (in mm water gauge). With the help of the surface tension of the ethanol (23° C.), the diameter of the largest pore (“Maximum Pore”, “maximum pore size”, “maximum pore diameter”) can be calculated.

The air pressure is then increased further, until air is passing through the sample over the entire surface (10 cm²) with an even distribution of bubbles but without foaming to determine the value for “many pores”. The air pressure is read off again and the relative pore diameter, i.e. the diameter of “many pores” is calculated.

The “maximum pore size” and “many pores” can be calculated as described above by using the following formula:

$$d = \frac{4 σ \cdot cos α}{p} \cdot 1.$$

$$d = Pore diameter [ μ m ]$$

$$p = Air pressure [ mN / {m}^{2} )$$

$$σ = Surface tension of the test liquid ( e . g . ethanol )$$

$$[ Ethanol at 23 ° C . σ = 21.330225 mN / m ]$$

$$α = Contact angle at the area where the liquid and the sample meet$$

$$( Conversion : 1 mm Water Gauge = 98.07 mN / {m}^{2} )$$

Thickness: the thickness as described in the present application has been measured according to DIN EN ISO 534:2012-02 but using a test pressure of 0.1 bar.

Basis weight: according to DIN EN ISO 536:2012-1

Flat sheet initial efficiency and dust holding capacity is determined according to ISO 19438:2003 (E) (ISO12103-1, A3 medium Test Dust, PTI Powder Technology Inc.), 200 cm² sample size, 0.71 L min-1 Flowrate, BUGL 100).

Filter element initial efficiency and dust holding capacity is determined according to ISO 19438:2003 (E).

Filter element pressure drop, according to ISO 4020:2001: The pressure drop depends on the filter geometry and it is <25 mbar @ 120 l/h @ 4 cSt according ISO 4020:2001. The same results were obtained in distilled water (deviating from the ISO 4020:2001).

Average fiber diameter: determined using a scanning electron microscope (such as for example a Phenom Fei) associated with a software allowing to measure the diameter (such as Fibermetric V2).

Sampling: For the nonwoven fabric, at least 5 points over the web width are selected and analysed.

### Recordings:

1. Sample sputtering
2. Random image based on optical image (no magnification), rasterize the selected area with at least 500× magnification (magnification depends on samples and will be selected so that the fibers can be identified).
3. Fiber diameter determination via “one click” method, every fiber has to be detected once; measuring points that detect the crossing points of fibers do not represent the fiber diameter and are removed manually.
7. Calculation

Average value and fiber diameter distribution is evaluated by the data obtained from Fibermetric V2 using an Excel table.

For each point, at least 100 fiber diameters will be recorded and the average value thereof will be calculated Thus, the five average values are combined to form an average value which is the average fiber diameter of the nonwoven. Accordingly, the average fiber diameter of the nonwoven is calculated based on at least 500 fibers.

Antimicrobial test: The test was carried out according to DIN EN ISO 20743:2013. In order to adapt the standard to the objective of this invention and deviating from the standard, the microorganisms Stenotrophomonas maltophilia and Pseudomonas aeruginosa were used.

Preparation of the inoculum: The inoculation was carried out from a preculture. This was prepared before the experiment started. For this purpose, one or two grown colonies of the bacterial strain were transferred from an agar plate to 40 ml of medium (placed in a 250 ml Erlenmeyer flask with baffles). The Erlenmeyer flask inoculated in this way was incubated at 30° C. overnight. Based on the optical density of this grown overnight culture, the cell number was determined using a calibration curve between the cell number and the optical density. In accordance with the target concentration in the test batch, a dilution was produced from it, with which the test batches were inoculated. For the investigation of the antimicrobial properties, the test batches were started with a microorganism concentration of approximately 106-107 CFU/ml each.

In accordance with the standard, the samples tested had a mass of 0.4 g. Before testing, the samples were irradiated with UV light for at least 2 hours. Subsequently, a 50 mL falcon tube is equipped with four sterilized media samples. In a next step, 50 μL of inoculum are applied on each sample resulting in a falcon tube, equipped with 4 samples inoculated with 0.2 mL of inoculate.

In the case of hydrophobic samples, the procedure for applying the microorganisms described above could not be carried out because the drops remained on the filter surface. For this reason, the reference filter pieces were immersed in water (“watered”) before being used in the tests. In addition, the application of the microorganisms could only take place drop by drop and were set up for 3-4 hours to dry.

The tubes with the t0 samples were opened again immediately after closing the tube in order to add the 20 mL SCDLP medium. The tubes were shaken with the vortex 5×5 sec each, then shaken for 30 s in a 30 cm arc. The medium was then poured off and stored on ice. The solution thus obtained with the shaken-out microorganisms was then diluted, plated on LB medium and evaluated using the plate counting method.

The tubes with the 24-hour samples were immediately brought into the 30° C. incubation chamber and the procedure was also carried out after 24 hours of incubation at 30° C.

After 24 hours and after 2 days, the colonies were counted.

For the evaluation, the determination of the cell number at time 0 and at the time of sampling is mandatory. To calculate the logarithmic reduction factor, the difference between the Log 10 values was calculated from the CFU (colony forming units) applied and from the CFU that were shaken out immediately after application or 24 hours after application. The evaluation was carried out via the presentation of the LRF.

### Test Conditions:

Incubation temperature 30° C.
Samples: mass 0.4 g used in 4 strips per batch

Evaluation: Calculation of the logarithmic reduction factor LRF for each material reference material and test material by using the CFU (colony-forming units) of the viable bacteria of the applied number of bacteria and at the time 24 h.

$$LRF = log ( CFU applied / CFUt )$$

$$LRF = log CFU applied - log CFUt$$

CFUt is the CFU after incubation at a time t.

### Coating Release Test:

8 ml of water per batch were mixed in a 15 ml Falcon tube with 2 test specimens with a size of 1 cm×1.5 cm each. At the beginning of the experiment, a Falcon tube was set up and provided for a sample. This respective sample container was no longer part of the experiment. The filter test specimens in water were incubated under the different conditions and samples were taken, processed and measured after a different test period. The investigations into the release of the ions were carried out from the liquid phase at the beginning of the experiment and after about 7, 28, 60 and 90 days. The time course of a possible washout should be recorded over a period of 3 months. The analysis of the anions was carried out using ion chromatography (such as ICP-3000 or ICP-6000).

### EXAMPLES

### Examples 1 to 3

A filter medium according to Table 1 was produced.

| | First | Second | Third | |
|---|---|---|---|---|
| | meltblown | spunbond | spunbond | Total |
| | layer | layer | layer | medium |
| Polymer | Polyester | Polyester | Polyester | |
| Basis weight | 60 | 80 | 20 | 168 |
| (g/m²) | | | | |
| Thickness (at | 0.35 | 0.30 | 0.15 | 0.97 |
| 0.1 bar) | | | | |
| Mean fiber | 1.4 | 25 | 25 | |
| diameter (μm) | | | | |
| Air permeability | | | | 66 |
| [L/m²s] | | | | |
| Initial efficiency | | | | 90 |
| (%) at 4 μm* | | | | |
| Dust holding | | | | 1.8 |
| capacity | | | | |
| (g/200 cm²)* | | | | |

*determined according to the test conditions described in the patent.

The exemplary medium was coated using a Foulard dipping technique. All three layers were coated. Test pieces of the medium were coated with the antimicrobial compounds listed in Table 2. The amount of antimicrobial compound in the examples was 0.001 wt % based on the total weight of the filter media.

TABLE 2

| | | LRF after | LRF after |
|---|---|---|---|
| | | 24 h for | 24 h for |
| | Antimicrobial | Stenotrophomonas | Pseudomonas |
| Example | compound | maltophilia | aeruginosa |
| 1 | Organic coating | >4 | >4 |
| | (quaternary | | |
| | ammonium | | |
| | salts and | | |
| | Poly(hexamethylene | | |
| | biguanide) | | |
| | hydrochloride | | |
| 2 | Zink-Ions | >2 | >2 |
| | (from Zink- | | |
| | pyrithion) | | |
| 3 | Silver Ions | >2 | >2 |
| | (From metallic | | |
| | silver | | |
| | nanoparticles) | | |

As can be seen from Table 2, all filter media according to the invention have a very good antimicrobial activity over a long period of time.

### Comparative Example 1

The same as example 1 but without coating. The LRF for both types of bacteria had negative values after 24 h.

1. A filter medium comprising:
i) a first meltblown layer, and
ii) a second spunbond layer,
wherein at least one of the first and second layers comprises at least an antimicrobial compound.

2. The filter medium according to claim 1, wherein the at least one antimicrobial compound is selected from the group consisting of metals, metal salts of pyrithione, quaternary ammonium salts, polyelectrolytes, polymeric biguanide derivatives or mixture thereof.

3. The filter medium according to claim 1, wherein only the meltblown layer comprises the at least one antimicrobial compound.

4. The filter medium according to claim 1 further comprising a third spunbond layer.

5. The filter medium according to claim 1, wherein the meltblown layer comprises polybutylene terephthalate (PBT) fibers.

6. The filter medium according to claim 1, wherein the at least one antimicrobial compound is selected from the group consisting of quaternary ammonium salts and polymeric biguanide derivatives.

7. The filter medium according to claim 1, wherein the amount of the at least one antimicrobial compound is about 0.0001 to about 2.0 wt % based on the total weight of the filter medium.

8. The filter medium according to claim 1, wherein the meltblown layer comprises fibers having an average fiber diameter of about 0.5 μm to about 5.0 μm.

9. The filter medium according to claim 1, wherein the spunbond layer comprises polybutylene terephthalate (PBT) or polyethylene terephthalate (PET).

10. The filter medium according to claim 4, wherein the meltblown layer includes a first side and a second side opposite the first side, wherein the second spunbond layer is adjacent the first side and the third spunbond layer is adjacent the second side.

11. The filter medium according to claim 3, wherein the antimicrobial compound is coated onto a surface of the first meltblown layer.

12. A liquid filter comprising:
a first endplate;
a second endplate; and
a filter medium disposed between the first and second endplates, the filter medium comprising an antimicrobial compound.

13. The filter of claim 12, wherein the filter medium comprises a first meltblown layer and a second spunbond layer in contact with the first melblown layer.

14. The filter of claim 12, further comprising an inflow opening and an outflow opening positioned such that a liquid flows radially through the filter medium.

15. The filter medium of claim 12 wherein the antimicrobial compound is selected from the group consisting of metals, metal salts of pyrithione, quaternary ammonium salts, polyelectrolytes, polymeric biguanide derivatives or mixture thereof.

16. The filter of claim 13, wherein only the meltblown layer comprises the at least one antimicrobial compound.

17. The filter of claim 13, wherein the meltblown layer comprises polybutylene terephthalate (PBT) fibers.

18. The filter of claim 12, wherein the antimicrobial compound is selected from the group consisting of quaternary ammonium salts and polymeric biguanide derivatives.

19. The filter of claim 12 wherein the antimicrobial compound is present in the filter medium in an amount of about 0.0001 to about 2.0 wt % based on the total weight of the filter medium.

20. The filter of claim 13, wherein the meltblown layer comprises fibers having an average fiber diameter of about 0.5 μm to about 5.0 μm.
